(19) United States
(12) Patent Application Publication
(10) Pub. No.: US 2005/0082797 A1
(43) Pub. Date: Apr. 21, 2005

(54) Expanding net integral with an inflatable airbag curtain

(76) Inventors: Richard Welford, Layton, UT (US); Kurt Gammill, Layton, UT (US)

Correspondence Address: Sally J. Brown;AUTOLIV ASP, INC., 3350 Airport Road, Ogden, UT, 84405, US

(21) Appl. No.: 10/687,434

(22) Filed: Oct. 16, 2003

(51) Int. Cl. B60R 21/22

(52) U.S. Cl. 280/730.2

(57) ABSTRACT

An expanding net integral with an inflatable airbag curtain is disclosed. The inflatable curtain includes an inflatable region that provides impact protection for a vehicle passenger in a lateral collision or rollover situation. The inflatable curtain also has an uninflatable region integral with the inflatable region for covering the side window openings not covered by the inflatable region. The uninflatable region could extend adjacent and below the inflatable region to provide for occupant retention in a collision or rollover situation.

### BACKGROUND OF THE INVENTION

1. Field of the Invention

The present invention relates to low-cost inflatable airbag curtains which include occupant retention capabilities. More particularly, the present invention relates to inflatable curtains which minimize the size of the inflation zones while still providing excellent occupant retention and impact protection.

2. Description of Related Art

Inflatable safety restraint devices, or airbags, are mandatory on most new vehicles. Airbags are typically installed as part of a system with an airbag module in the steering wheel on the driver's side of a car and in the dashboard on the passenger side of a car. In the event of an accident, a sensor within the vehicle measures abnormal deceleration and triggers the ignition of an explosive charge contained within an inflator. Expanding gases from the charge travel through conduits and fill the airbags, which immediately inflate in front of the driver and passenger to protect them from harmful impact with the interior of the car. Side impact airbag systems have also been developed in response to the need for similar protection from lateral impacts between a passenger and the side of a vehicle's interior. This might occur when another vehicle collides with the side of the car, or in a rollover situation where the side of the car is repeatedly impacting the ground.

One form of these airbags, which are commonly referred to as “inflatable curtains” may be mounted on or near the roof rail, or the portion of the frame that extends along a length of the vehicle between the side windows and the roof. The inflatable curtain is typically compacted, i.e., folded, rolled, or processed through a combination of folding and rolling, to stow the cushion behind a headliner covering the interior of the roof of the vehicle. The curtain may be designed to unfold or unroll downward to inflate beside a passenger, covering the windows, doors, and lateral surfaces of the vehicle to keep the passenger from hitting the door or window during lateral impact.

The area of an inflatable curtain needed for head protection is generally much smaller than the area needed to provide for occupant retention. Occupant retention is necessary to prevent the passenger's limbs, head, or body from protruding through or ejecting out of the side windows in a lateral impact or rollover situation. Generally, occupant retention is accomplished through the large inflated regions of the inflatable curtain used to simultaneously provide impact protection. In order to provide occupant retention the curtain must be large enough to cover a vehicle's side window openings. In conventional configurations the inflated regions are large enough to cover the window openings, thus providing both impact protection and occupant retention.

Although the use of inflatable zones within the curtain are necessary to provide impact protection, the size and area of the inflatable zones necessary to meet these requirements is much smaller than what is required to mitigate occupant ejection. Despite the effectiveness of using large inflated regions in airbag curtains for providing for both impact protection and occupant retention, the use of large cushions in airbag curtains can be expensive.

Having large cushion areas within an inflatable curtain that cover window openings requires the use of a large inflator. Large inflators are more expensive than their smaller counterparts. The cost associated with the use of large inflators is exacerbated by the need to use especially large curtains with multiple inflatable zones in many vans and large sport utility vehicles.

Moreover, the inflatable curtain must be made of a material strong enough to withstand the pressure exerted against it by the expanding gases formed when the inflator is activated. The inflated chamber must also simultaneously withstand an impending passenger against it in a collision. The inflated chamber is often made of a tightly woven textile material that can withstand these pressures and retain the pressurized gases for a sufficient time to cushion a vehicle passenger. The portion of the inflatable curtain used for occupant retention does not necessarily have these same demands because this portion need not provide cushioning. Therefore, in conventional systems the more expensive material required for an inflatable cushion is often used throughout the entire curtain in sections not requiring such expensive material.

Furthermore, an inflatable curtain that has a large inflatable zone can be quite bulky even after a mechanized compaction process. The bulkier the inflatable curtain, the larger the storage space required to house the inactivated inflatable curtain. Unfortunately, it is often difficult to properly mount and hide inflatable curtains in vehicles. Inflatable curtains mounted in a visible, accessible location are undesirable because they are unsightly and may be tampered with by children and others. However, the space between the roof and the headliner is necessarily limited to minimize the profile of the vehicle.

Accordingly, a need exists for an inflatable curtain that provides for both impact protection and occupant retention while mitigating the costs associated with using large inflatable zones within the curtain. It is desirable that an inflatable curtain satisfy the above requirements and yet use a smaller inflator. It is further desirable to limit the use of expensive textile material throughout the entire inflatable curtain. It is also desirable that such a system minimize the volume required to store the inactivated inflatable curtain.

### SUMMARY OF THE INVENTION

The apparatus of the present invention has been developed in response to the present state of the art, and in particular, in response to the problems and needs in the art that have not yet been fully solved by currently available inflatable airbag curtain systems. Thus, the present invention provides a cost-effective inflatable airbag curtain system that maintains the ability to provide for impact protection and occupant retention. The inflatable curtain avoids the use of expensive cushion material throughout the curtain and reduces the required inflator size by limiting the inflatable regions of the curtain to the areas needed to provide impact protection for a vehicle passenger. The remaining area of the inflatable curtain necessary to prevent ejection of the occupant is uninflatable.

In accordance with the invention as embodied and broadly described herein in the preferred embodiment, an inflatable airbag curtain is provided. According to one configuration, the inflatable curtain may have an inflatable zone that provides impact protection for a vehicle passenger and is located between the vehicle passenger's head and the side of the vehicle when the curtain is deployed. An uninflatable zone comprises the remaining area of the airbag curtain and covers the side window openings that are not covered by the inflatable zone. The inflatable zone and the uninflatable zone are integral with each other forming a single sheet or plane. The uninflatable zone covers the side window opening between the vehicle passenger and the side of the vehicle to keep the passenger's limbs, head and body within the vehicle during a lateral impact or rollover situation.

The top edge of the inflatable curtain is ordinarily mounted to the roof rail of the vehicle. The bottom edge of the curtain then extends downward to cover the side window openings. In an A to C system, the front edge of the curtain is located proximate the A-pillar of the vehicle and the rear edge is located proximate the C-pillar of the vehicle. In such a system there are generally two inflatable zones. The first is located proximate the head of the vehicle passenger in the front seat. The second inflatable zone is located proximate the head of a vehicle passenger in the rear seat. The first inflatable zone has a generally larger area than the second inflatable zone because most front seats can move forward, rearward, up and down while the rear seat generally maintains a static position. A larger inflatable zone is therefore needed proximate the front seat passenger because the passenger's head can be located in various positions depending upon the positioning of the front seat.

The uninflatable zone may be perforated throughout or solid throughout. The perforations can expand to moderate the tension between anchor points of the inflatable curtain when deployed. The uninflatable zone is preferably thinner than the material of the inflatable zones. However, the uninflatable zone may be constructed of the same parent material as the inflatable zones. The thinner, less-expensive material used for the uninflatable zones may be netting, webbing, mesh, or other textile material. Since the uninflatable zone is integral with the inflatable zones, they are both folded or rolled and housed together typically in a wrap or sock when stored in an undeployed state.

A pre-tensioning device may be used to position the inflatable curtain, particularly the uninflatable zone, in its proper position between the vehicle passenger and the side of the vehicle upon deployment. An active pre-tensioning device may be used to facilitate the deployment of the inflatable curtain and expand the uninflatable zone to a proper position covering the side window openings. The active pre-tensioner may be a pyrotechnic pre-tensioner or a similar active tethering system attached to the uninflatable zone that pulls down on the inflatable curtain to achieve proper deployment. A passive pre-tensioning device could also be used, such as a passive tethering system. A passive device would be used not to expand the deployment of the inflatable curtain, but to maintain the curtain adjacent the side of the vehicle. Alternatively, the tension provided by the inflatable zones may be sufficient to expand and maintain the uninflatable zone adjacent the side window openings without the aid of a pre-tensioning device.

The uninflatable zone may also extend adjacent the inflatable zones. A portion of the uninflatable zone may extend forward from the first inflatable zone proximate the front seat toward the A-pillar of the vehicle. Another portion of the uninflatable zone may extend rearward from the second inflatable zone proximate the rear seat toward the C-pillar of the vehicle. It should be recognized that various configurations of the uninflatable zone are possible, such as extending adjacent the first inflatable zone near the front edge of the inflatable curtain, while not extending rearward of the second inflatable zone and vice versa. The uninflatable zone may be completely perforated, partially perforated, or not perforated at all.

According to another alternative, the inflatable airbag curtain may comprise three inflatable zones adjacent a front, middle, and rear seat of a large vehicle such as a van or a large sport utility vehicle. The inflatable curtain then extends from the A-pillar to the D-pillar of the vehicle in A to D systems. The uninflatable zone of this system is located below, between, and adjacent the inflatable zones. It also could be completely perforated, partially perforated, or not perforated at all.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side plan view of an inflatable curtain in a deployed state, mounted within a vehicle shown partially cut-away;

FIG. 2 is a side plan view of an inflatable curtain in a partially deployed state;

FIG. 3 is a side plan view of an inflatable curtain in a deployed state;

FIG. 4 is a side plan view of an inflatable curtain in a stored state mounted inside a vehicle;

FIG. 5 is a side plan view of an inflatable curtain in a partially deployed state mounted inside a vehicle;

FIG. 6 is a side plan view of an inflatable curtain in a deployed state mounted inside a vehicle; and

FIG. 7 is an elevated perspective view of an inflatable curtain in a deployed state, extending from an A-pillar to a D-pillar mounted inside a vehicle.

### DETAILED DESCRIPTION OF THE PREFERRED EMBODIMENTS

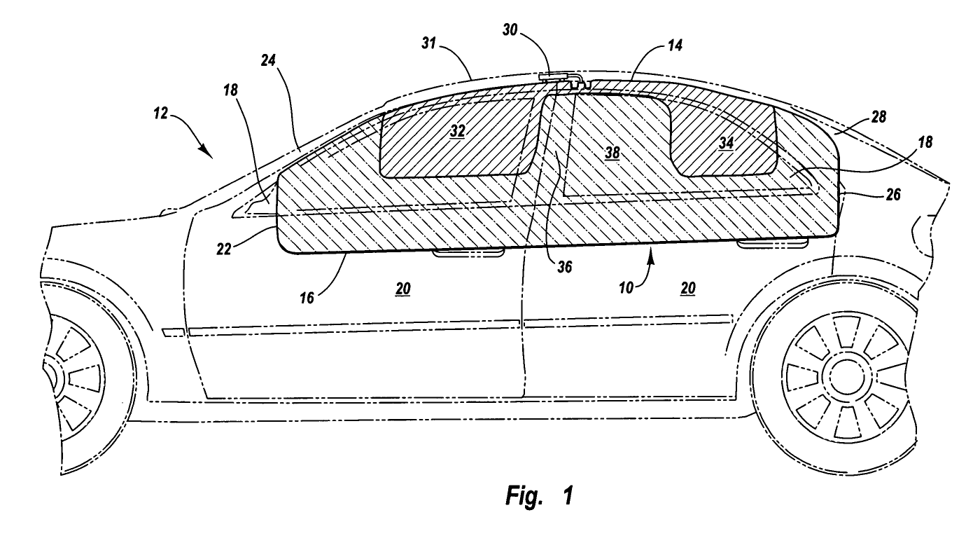

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 7, is not intended to limit the scope of the invention, as claimed, but is merely representative of presently preferred embodiments of the invention.

Referring to FIG. 1, an inflatable airbag curtain 10 is depicted in a deployed state within a motor vehicle 12 in a partially cut-away, side plan view. The inflatable curtain 10 has a top edge 14 mounted on or near a roof rail inside the vehicle 12. The inflatable curtain 10 has a bottom edge 16 that extends below the window openings 18 on the side doors 20 of the vehicle 12. The bottom edge 16 could extend further down to the belt line to provide maximum occupant retention for passengers. The inflatable curtain 10 has a front edge 22 adjacent an A-pillar 24 of the vehicle 12, and a rear edge 26 adjacent a C-pillar 28 of the vehicle 12 (“A to C systems”). When deployed, the inflatable curtain 10 unfolds or unrolls and extends down from proximate the roof rail toward the vehicle floor between the side doors 20 and a vehicle passenger.

An inflator 30 is shown disposed within an envelope between the roof 31 and the headliner proximate the roof rail. The inflator 30 could be disposed at various locations adjacent the inflatable curtain 10, such as near the A-pillar 24 or the C-pillar 28. The inflator 30 is used to rapidly inflate the curtain 10 in a lateral collision or rollover situation. The inflator 30 could contain a stored quantity of pressurized inflation fluid or a combination of pressurized inflation fluid and ignitable material for heating the inflation fluid. Alternatively, the inflator 30 may be a pyrotechnic inflator that uses the combustion of gas-generating material to generate the inflation gas.

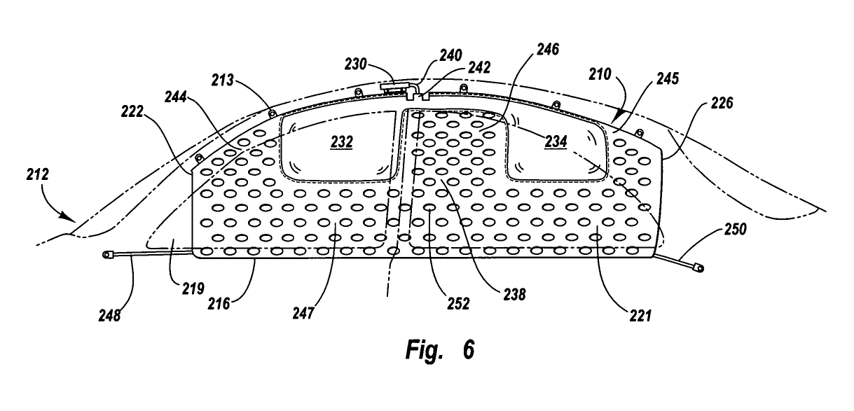

As depicted in FIG. 1, the deployed inflatable curtain 10 is maintained in its position adjacent the side doors 20 by the tension and pressure provided by the first and second inflatable zones 32, 34. A passive pre-tensioning device such as tethers 248, 250 as shown in FIG. 6 may also be used to maintain the inflatable curtain 10 against the side structure of the vehicle 12. Alternatively, an active pre-tensioning device, such as a pyrotechnic pre-tensioner could also be employed to facilitate curtain deployment by pulling the bottom edge 16 down so the inflatable curtain 10 can rapidly achieve its proper position.

Referring still to FIG. 1, the inflatable curtain 10 has several zones that accomplish different objectives. The first inflatable zone 32 covers an area necessary to provide impact protection for a vehicle passenger in a front seat of the vehicle 12. The first inflatable zone 32 is adjacent the top edge 14 of the inflatable curtain 10 and the B-pillar 36 of the vehicle 12 and extends towards the A-pillar 24. The first inflatable zone 32 is basically situated in the top half of the window 18 at the corner defined by the B-pillar 36 and the roof 31. The first inflatable zone 32 is an inflatable cushion and is generally rectangular in shape, but could be elliptical, circular, or other shape.

The first inflatable zone 32 is located adjacent the center of gravity of a vehicle passenger's head. The first inflatable zone 32 is configured to cushion the vehicle passenger's head in a lateral impact or rollover situation. Those with skill in the art will recognize that the size of the first inflatable zone 32 will vary depending upon the relative orientation of the front seat and the side door 20, as well as the different possible heights of vehicle passengers. The height of vehicle occupants can vary for instance from male to female passengers. The front seat of most vehicles can also move forward, rearward, up and down. Therefore, the first inflatable zone 32 will have an area sufficient to compensate for the variable head positions of different vehicle passengers. Approximately a 100 millimeter margin around the probable head impact areas may be included in the first inflatable zone 32 in order to assure passenger protection.

As depicted in FIG. 1, A to C airbag systems may have a second inflatable zone 34 for providing impact protection for a vehicle passenger in a rear seat. The second inflatable zone 34 is generally located adjacent the top 14 and rear 26 edges of the inflatable curtain 10, proximate the C-pillar 28 and extending towards the B-pillar 36 of the vehicle 12. The shape of the second inflatable zone 34 is also generally rectangular, but, like the first inflatable zone 32, it can be elliptical, circular, or other shape able to provide the necessary coverage areas for impact protection of a passenger's head.

The size and area necessary to provide impact protection for a vehicle passenger in a rear seat is determined much the same way as that of the first inflatable zone 32. However, the coverage area necessary to provide impact protection is typically smaller with the second inflatable zone 34 than the first inflatable zone 32 because the rear seat is not usually able to move forward, rearward, and up and down like the front seat. Therefore, the variability of the position of the vehicle passenger's head is not as great in the rear seat. Like the first inflatable zone 32, approximately a 100 millimeter margin around the probable head impact areas may be included in the second inflatable zone 34 in order to assure proper passenger protection.

The inflatable curtain 10 also has an occupant retention zone 38 that encompasses the remaining areas of the inflatable curtain 10 outside of the first and second inflatable zones 32, 34. The occupant retention zone 38 can extend between, below, and adjacent the inflatable zones 32, 34 to cover the window openings 18. The occupant retention zone 38 extends to below the window openings 18. The occupant retention zone 38 further extends adjacent the first inflatable zone 32 toward the A-pillar 24, and adjacent the second inflatable zone 34 toward the C-pillar 28. Such coverage of the side structure of the vehicle 12 is necessary, not for impact protection, but for occupant ejection mitigation. By having the inflatable curtain 10 extend to these remaining areas, the passenger's limbs, head and body are kept within the passenger compartment. The occupant retention zone 38 has traditionally been, but need not, be inflatable.

Referring to FIG. 2, an embodiment of the present inflatable curtain 110 is depicted in a side plan view, in a partially-deployed state. The inflatable curtain 110 has a top edge 114 for mounting on or adjacent a roof rail of a vehicle. Extending down from the top edge 114, adjacent the front edge 122, is the first inflatable zone 132. The first inflatable zone 132 provides impact protection for a vehicle passenger in a front seat when deployed between that passenger and a side structure of the vehicle. A second inflatable zone 134 extends down from the top edge 114, adjacent the rear edge 126 of the inflatable curtain 110. The second inflatable zone 134 provides impact protection for a vehicle passenger in a rear seat by extending between that passenger and the side structure of the vehicle.

The first and second inflatable zones 132, 134 are shown in an inflated state after being filled with inflation gas produced by the inflator 130. The inflator 130 in this configuration has a gas conduit 140 that interconnects the inflator 130 and the inlet port 142 of the inflatable curtain 110. The inflatable zones 132, 134 are generally constructed of a tightly woven textile material that can withstand the pressures created by the activated inflator 130 and an impinging vehicle passenger in a collision scenario. The inflatable zones 132, 134 are constructed using conventional methods, including, but not limited to sewing, one piece weaving, or radio-frequency welding.

The inflatable curtain 110 has an uninflatable zone 138 that extends below and between the first and second inflatable zones 132, 134. The uninflatable zone 138 is an integral part of the inflatable curtain 110 with the first and second inflatable zones 132, 134, meaning it is not a separate sheet, but forms one sheet having inflatable zones 132, 134 and an uninflatable zone 138 in substantially the same plane. A separately manufactured uninflatable zone 138 could also be integrated into the inflatable zones 132, 134 by attaching a separate uninflatable portion through weaving, sewing, bonding, welding, and the like. The uninflatable zone 138 could be made of the parent material of the inflatable zones 132, 134. However, preferably the uninflatable zone 138 is constructed of a thinner, less expensive material that can be folded and rolled up with the thicker material of the inflatable zones 132, 134 in a stored state, thus requiring a smaller storage space. The smaller storage space allows for the inflatable curtain 110 to fit into a smaller housing envelope making it easier to package between the roof and the headliner adjacent the roof rail while minimizing the profile of the vehicle.

The uninflatable zone 138 could be constructed of netting, webbing, mesh or other perforated or non-perforated textile material. The uninflatable zone 138 has a first portion 144 disposed between the first and second inflatable zones 132, 134. The first portion 144 provides occupant retention protection for areas between the inflatable zones 132, 134 and also gives structural support for the inflatable zones 132, 134 by moderating the tension between each zone and holding them in a proper orientation between the vehicle passenger and the side structure of the vehicle. The first portion 144 of the uninflatable zone 138 shown in FIG. 2 is solid and not perforated. However, the first portion 144 could be perforated to provide for additional elasticity between inflatable zones 132, 134.

The uninflatable zone 138 of the inflatable curtain 110 shown in FIG. 2 also has a second portion 146 that extends below both inflatable zones 132, 134 and the first portion 144 of the uninflatable zone 138. As shown in FIG. 2, the second portion 146 has not yet fully deployed. The expansion of the second portion 146 could be facilitated by an active pre-tensioning device such as an active tethering system.

An active tethering system is shown in FIG. 2 having a first tether 148 attached adjacent the bottom edge 116 of the second portion 146 of the uninflatable zone 138 of the inflatable curtain 110 near its front edge 122. A second tether 150 is also attached to the bottom edge 116 of the second portion 146 of the uninflatable zone 138 of the inflatable curtain 110 near its rear edge 126. The tethers 148, 150 need not be attached at the bottom corners, but could be attached anywhere around the periphery of the inflatable curtain 110, or toward the center, near or on the inflatable zones 132, 134. Furthermore, one tether, or three or more could be used if desired.

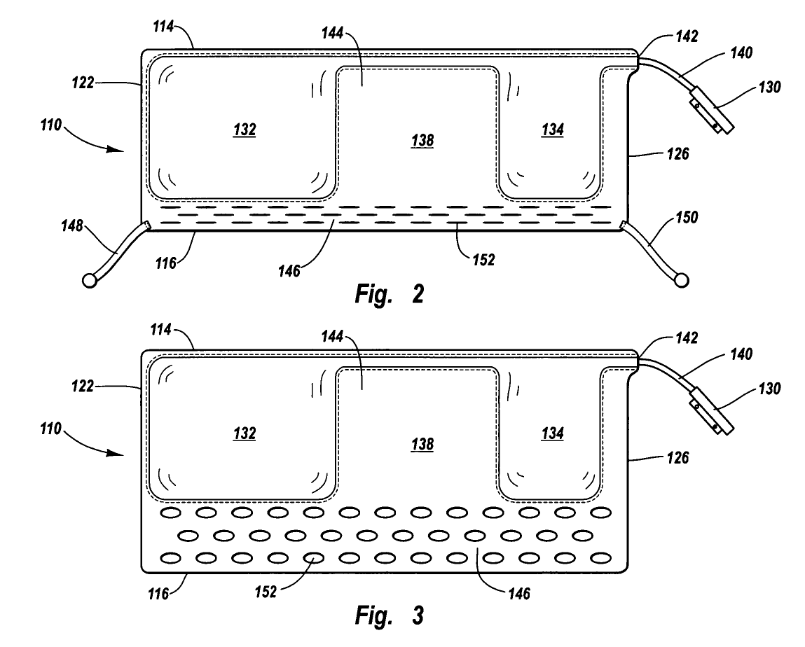

When activated, the tethers 148, 150 pull the uninflatable zone 138 downward. The downward stretching causes the apertures 152 (shown in FIG. 3) of the perforated second portion 146 to expand, providing maximum coverage of the side window openings of a vehicle and also providing structural support for the inflatable curtain 110 by moderating tension between the attachment points of the first and second tethers 148, 150. Alternatively, an active pyrotechnic pre-tensioner could be used to expand the second portion 146 of the uninflatable zone 138.

Referring to FIG. 3, the inflatable curtain 110 is depicted in a side elevation view in a fully deployed state. The second portion 146 of the uninflatable zone 138 has extended downward, away from the top edge 114 of the inflatable curtain 110. This could be accomplished by activation of the tethering system described in accordance with FIG. 2 where the tethers are retracted and pull the second portion 146 of the uninflatable zone 138 downward. However, the fully deployed inflatable curtain 110 in FIG. 3 is shown absent a tethering system. Here the uninflatable zone 138 expands and is maintained in its position adjacent the side structure of the vehicle through the tension and position provided by the activated inflatable zones 132, 134. The second portion 146 of the uninflatable zone 138 is a netting material that can stretch and expand upon full deployment.

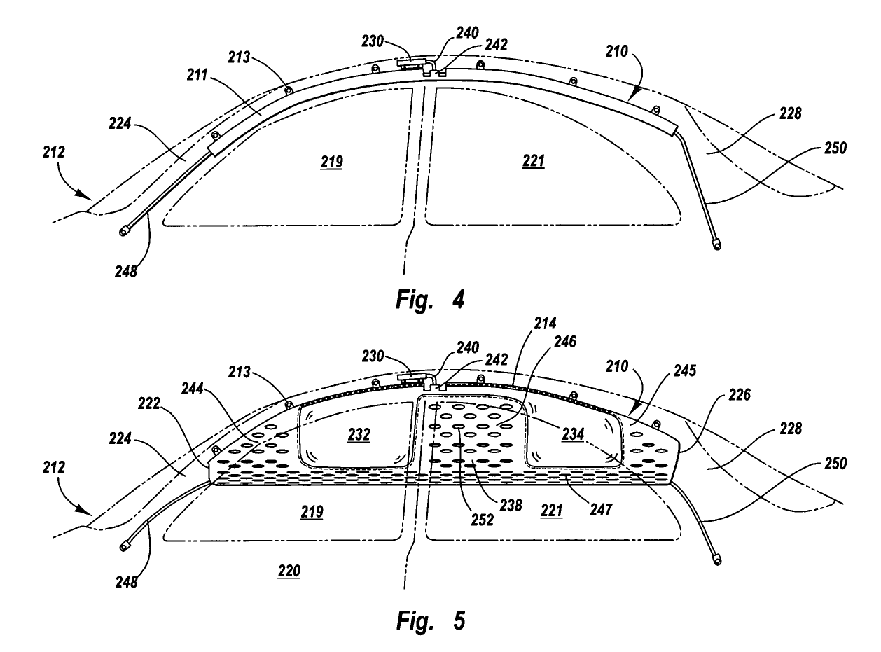

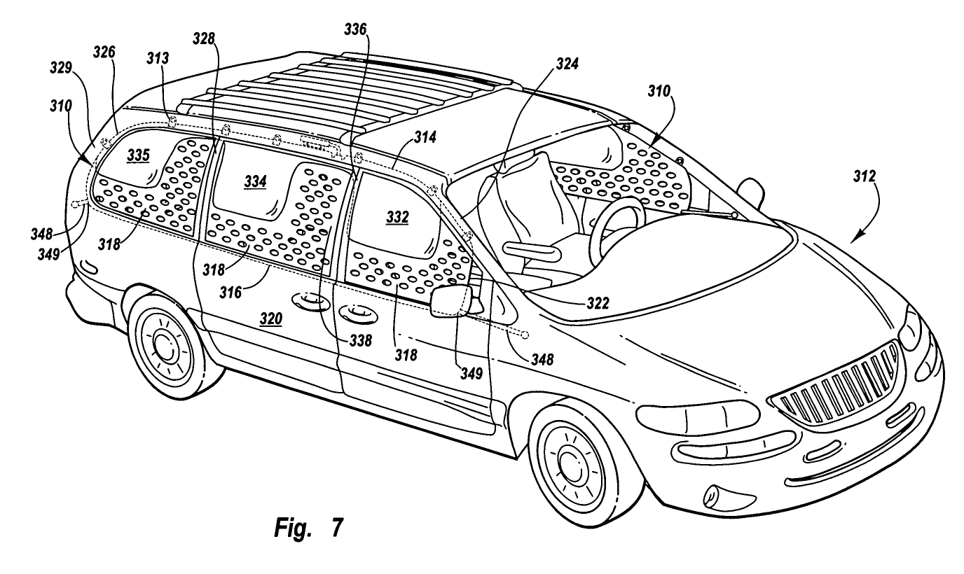

Referring to FIG. 4, an alternative embodiment of the inflatable curtain 210 is depicted from a side plan view in a stored state mounted inside a vehicle 212. The inflatable curtain 210 is housed inside a wrap 211 and mounted to a roof rail by attachment clips 213. The inflator 230 is also mounted proximate the roof rail between the roof and the headliner and is located near the center of the inflatable curtain 210. The inflator 230 is connected to the inlet port 242 of the inflatable curtain 210 by a gas conduit 240. The inflatable curtain 210 extends from the A-pillar 224 to the C-pillar 228. Alternative embodiments of the present invention could extend from the A-pillar 224 to a D-pillar in larger A-D vehicles such as vans and large sport utility vehicles (see FIG. 7).

A first tether 248 is attached to the inflatable curtain 210 adjacent the A-pillar 224, while a second tether 250 is attached to the inflatable curtain 210 adjacent the C-pillar 228. The first and second tethers 248, 250 are part of an active pre-tensioning device for expanding the inflatable curtain 210 downward alongside the side windows 219, 221. A passive tethering system could also be used to maintain a deployed position instead of facilitating deployment.

Referring to FIG. 5, the inflatable curtain 210 is shown from a side plan view in a partially deployed state when mounted inside a vehicle 212. The inflatable curtain 210 has a top edge 214 that is mounted to the roof rail of the vehicle 212 by attachment clips 213. The front edge 222 is located adjacent the A-pillar 224, while the rear edge 226 is located adjacent the C-pillar 228. Extending down from the top edge 214 of the inflatable curtain 210 and adjacent the front seat window 219 is the first inflatable zone 232 disposed between the side structure 220 of the vehicle 212 and the vehicle passenger.

The first inflatable zone 232 provides impact protection for a vehicle passenger's head in a front seat during a lateral impact or rollover situation. A second inflatable zone 234 extends down from the top edge 214 of the inflatable curtain 210 adjacent the rear seat window 221. The second inflatable zone 234 provides impact protection for a vehicle passenger's head in a rear seat during a collision by extending between the passenger and the side structure 220 of the vehicle 212.

The first and second inflatable zones 232, 234 are in an inflated state after activation by the inflator 230. The inflatable zones 232, 234 of this embodiment are constructed of a tightly woven textile material, strong enough to withstand the pressures exerted against it by the inflation gases generated by the activated inflator 230 and an impinging vehicle passenger. The first inflatable zone 232 typically covers a larger area than the second inflatable zone 234 because the front seat of the vehicle 212 usually can move forward, rearward, up and down. Consequently, the probable location of the vehicle occupant's head covers a larger area than it would in the rear seat because the rear seat typically cannot be adjusted like the front seat.

Referring still to FIG. 5, the inflatable curtain 210 has an uninflatable zone 238 that extends below, between and adjacent the first and second inflatable zones 232, 234. The uninflatable zone 238 is integral with the first and second inflatable zones 232, 234, in that the inflatable curtain 210 forms one uniform sheet. The uninflatable zone 238 is preferably constructed of a material different from the inflatable zones 232, 234, but could be constructed of the same parent material as the inflatable zones 232, 234. It is desirable that the uninflatable zone 238 is a thinner, less expensive material that can be folded or rolled up with the thicker inflatable zones 132, 134 when in a stored state. This thinner material is preferred because it results in smaller storage space requirements for the inflatable curtain 210 in a stored state (see FIG. 4).

The uninflatable zone 238 could be integrated with the inflatable zones 232, 234 by weaving, sewing, bonding, welding, and the like. If the parent material is used, the uninflatable zone 238 could be constructed simultaneously with the inflatable zones 232, 234 through sewing, radio frequency welding, or one piece woven technology. As depicted in FIG. 5, perforated netting is used instead of the parent material. Mesh, webbing, or other textile material could be used in a perforated or non-perforated state. The apertures 252 in the perforated uninflatable zone 238 provide for greater elasticity, expansion, and proper tensioning of the inflatable curtain 210.

For convenience, the uninflatable zone 238 will be referred to in four portions. The first three portions have an edge adjacent the top edge 214 of the inflatable curtain 210. The first portion 244 is adjacent the first inflatable zone 232 on a forward side and extends forward, toward the A-pillar 224 of the vehicle 212. The second portion 246 is located between the first and second inflatable zones 232, 234. The third portion 245 is adjacent the second inflatable zone 234 on a rearward side and extends rearward, toward the C-pillar 228 of the vehicle 212. All three portions of the uninflatable zone 238 are perforated providing elasticity to moderate the tension of the inflatable curtain 210 when deployed. The fourth portion 247 of the uninflatable zone 238 is not fully expanded in FIG. 5.

Referring to FIG. 6, the inflatable curtain 210 is shown from a side plan view in a fully deployed state mounted inside a vehicle 212. The fourth portion 247 of the uninflatable zone 238 is shown expanded, below the inflatable zones 232, 234 and the first, second and third portions 244, 246, 245 of the uninflatable zone 238. When fully deployed, the uninflatable zone 238 can stretch and expand. The expansion of the uninflatable zone 238 is facilitated by the use of the first and second tethers 248, 250. The active tethering system is used to achieve proper position of the inflatable curtain 210 to cover the side windows 219, 221 adjacent a vehicle passenger.

The first tether 248 is attached adjacent the bottom edge 216 of the fourth portion 247 of the uninflatable zone 238 near the front edge 222 of the inflatable curtain 210. The second tether 250 is attached adjacent the bottom edge 216 of the fourth portion 247 of the uninflatable zone 238 near the rear edge 226 of the inflatable curtain 210. The tethers 248, 250 need not be attached at the bottom corners of the inflatable curtain 210, but could be located elsewhere in order to facilitate expansion and proper tensioning of the inflatable curtain 210. Fewer or more tethers could be employed, as well as none at all. A passive tethering system may also be used, not for expansion purposes, but to maintain the inflatable curtain 210 in its proper deployed position. If no pre-tensioning device is used, the inflatable zones 232, 234 would provide the tension and expansion direction needed for the uninflatable zone 238 to properly deploy.

The expansion of the fourth portion 247 of the uninflatable zone 238 extends the bottom edge 216 of the inflatable curtain 210 downward to cover the window openings 219, 221. The fully deployed uninflatable zone 238 provides occupant retention by keeping the passenger's limbs, head and body within the passenger compartment of the vehicle 212. The expansion of the uninflatable zone 238 also causes the apertures 252 to expand, allowing the uninflatable zone 238 to cover a large area and also provide structural support for the inflatable curtain 210 by moderating tension between the anchoring points where the first and second tethers 248, 250 are located.

Referring to FIG. 7, another alternative embodiment of the inflatable curtain 310 mounted inside a motor vehicle 312 is shown from a perspective view. The inflatable curtain 310 has a top edge 314 that is mounted near the roof rail through attachment clips 313. The bottom edge 316 of the inflatable curtain 310 extends to below the side window openings 318. The inflatable curtain 310 has a front edge 322 adjacent the A-pillar 324 and its rear edge 326 is adjacent the D-pillar 329.

The inflatable curtain 310 is similar in concept to the previously disclosed embodiments, with the exception of having three inflatable zones. The first inflatable zone 332 extends downward from the top edge 314 of the inflatable curtain 310 proximate the B-pillar 336 and is located between the front seat passenger and the side structure 320 of the vehicle 312. The second inflatable zone 334 also extends down from the top edge 314 of the inflatable curtain 310 proximate the C-pillar 328 between a passenger in the middle seat and the side structure 320 of the vehicle 312. The third inflatable zone 335 extends down from the top edge 314 adjacent the rear edge 326 of the inflatable curtain 310 proximate the D-pillar 329 between a passenger in the rear seat and the side structure 320 of the vehicle 312. All three inflatable zones 332, 334, 335 provide impact protection for a vehicle passenger's head during a lateral impact or rollover situation.

The inflatable curtain 310 has an uninflatable zone 338 that extends adjacent, below, between, and is integral with the three inflatable zones 332, 334, 335. The uninflatable zone 338 is located between the first and third inflatable zones 332, 335 and between second and third inflatable zones 334, 335. The uninflatable zone 338 also extends adjacent the first inflatable zone 332 toward the A-pillar 324 and beneath all three inflatable zones 332, 334, 335 to cover the side window openings 318. The uninflatable zone 338 is a perforated material such as netting, webbing, or mesh that helps to moderate the tension created between anchoring points 349 of the tether 348 attachments when an active tethering system is employed to expand the uninflatable zone 338 upon deployment.

As with the embodiments disclosed above, the uninflatable zone 338 is preferably constructed of a thinner, less expensive material than that of the inflatable zones 332, 334, 335. Furthermore, the entire uninflatable zone 338 need not be perforated. The uninflatable zone 338 protects against occupant ejection during a collision or rollover event by preventing a passenger's limbs, head and body from protruding out the side windows 318 of the vehicle 312.

Accordingly, the inflatable airbag curtain of the present invention presents significant improvements in cost effectiveness while maintaining the functional requirements of impact protection and occupant retention. By limiting the inflatable portion of the inflatable airbag curtain to the areas necessary to achieve impact protection for vehicle passengers, a smaller inflator is required. The use of a smaller inflator reduces costs by requiring less pyrotechnic material or compressed inflation fluid. A smaller inflator also minimizes packaging size of the airbag system, allowing the inflator to fit in a smaller envelope space on the vehicle, which helps to preserve vehicle aesthetics.

By using a less expensive material for the uninflatable zone of the inflatable airbag curtain, the cost of producing the inflatable curtain is reduced. The material required and the method of construction for the inflatable zones of the curtain can be expensive if used on areas of the curtain that are not essential for impact protection. Therefore, by reducing the amount of expensive material used by limiting the size of the inflatable zones, the present invention provides a cost savings while maintaining its ability to provide adequate occupant retention.

Furthermore, using a thinner material for the uninflatable zones reduces the storage space required when the uninflatable and inflatable zones of the curtain are rolled or folded together and placed in a wrap. By reducing the volume of the storage area between the vehicle roof and headliner, the profile of the vehicle can be maintained.

Additionally, by using a perforated uninflatable zone, the tension of the inflatable curtain between tethering anchor points is moderated by the expansion of the apertures of the uninflatable zone, thus maintaining the structural integrity of the curtain. The advantages of the present invention are amplified when using large inflatable curtain systems, such as those that extend from an A-pillar to a D-pillar because the uninflatable zone is larger than in smaller curtain systems providing a more significant cost savings and a greater reduction in storage requirements.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An automobile side curtain airbag, comprising:
a first inflatable zone for providing impact protection for a vehicle occupant; and
an integral uninflatable zone for covering a window opening on a side structure of the vehicle not covered by the first inflatable zone.

2. The automobile side curtain airbag of claim 1, wherein the uninflatable zone is perforated.

3. The automobile side curtain airbag of claim 1, wherein the uninflatable zone extends below the first inflatable zone.

4. The automobile side curtain airbag of claim 1, wherein the uninflatable zone extends adjacent the first inflatable zone.

5. The automobile side curtain airbag of claim 2, further comprising a second inflatable zone, wherein the uninflatable zone has a first portion disposed between the first inflatable zone and the second inflatable zone.

6. The automobile side curtain airbag of claim 5, wherein the first portion of the uninflatable zone is not perforated.

7. The automobile side curtain airbag of claim 5, wherein the first inflatable zone has an area larger than the second inflatable zone.

8. The automobile side curtain airbag of claim 5, further comprising a third inflatable zone, wherein the uninflatable zone has a second portion disposed between the second inflatable zone and the third inflatable zone.

9. The automobile side curtain airbag of claims 8, wherein the first and second portions of the uninflatable zone are not perforated.

10. The automobile side curtain airbag of claim 1, wherein the side curtain airbag has a top edge mountable near a roof on a side of the vehicle and a bottom edge extendable below the window opening on the side structure of the vehicle when the side curtain airbag is deployed.

11. The automobile side curtain airbag of claim 10, wherein the side curtain airbag further has a front edge adjacent to an A-pillar of the vehicle and a rear edge adjacent to a C-pillar of the vehicle when the side curtain airbag is mounted inside the vehicle and deployed.

12. The automobile side curtain airbag of claim 10, wherein the side curtain airbag further has a front edge adjacent to an A pillar of the vehicle and a rear edge adjacent to a D pillar of the vehicle when the side curtain airbag is mounted inside the vehicle and deployed.

13. The automobile side curtain airbag of claim 1, further comprising a pre-tensioning device connected to the side curtain airbag for positioning the uninflatable zone between the vehicle occupant and the side structure of the vehicle when the side curtain airbag is mounted inside the vehicle and deployed.

14. The automobile side curtain airbag of claim 13, wherein the pre-tensioning device comprises a tether connected to the uninflatable zone, the tether resisting movement of the uninflatable zone away from the side structure of the vehicle when the side curtain airbag is mounted inside the vehicle and deployed.

15. The automobile side curtain airbag of claim 1, wherein the uninflatable zone is thinner than a material of the first inflatable zone, the uninflatable zone is constructed of a material selected from the group consisting of netting, webbing, and mesh.

16. The automobile side curtain airbag of claim 1, wherein the uninflatable zone is a solid sheet.

17. The automobile side curtain airbag of claim 1, wherein the uninflatable zone is constructed of a material of the inflatable zone.

18. An automobile side curtain airbag assembly, comprising:
a first inflatable zone for providing impact protection for a vehicle occupant in a front seat of a vehicle;
a second inflatable zone for providing impact protection for a vehicle occupant in a seat behind the front seat of the vehicle; and
an integral, perforated uninflatable zone extending below and between the first and second inflatable zones, for covering window openings on a side structure of the vehicle not covered by the first or second inflatable zones.

19. The automobile side curtain airbag of claim 18, wherein the uninflatable zone extends adjacent a forward side of the first inflatable zone.

20. The automobile side curtain airbag of claim 19, wherein the uninflatable zone extends adjacent a rearward side of the second inflatable zone.

21. The automobile side curtain airbag of claim 20, wherein the first inflatable zone has an area larger than the second inflatable zone.

22. The automobile side curtain airbag of claim 21, further comprising a pre-tensioning device connected to the side curtain airbag for positioning the uninflatable zone between vehicle occupants and the side structure of the vehicle when the side curtain airbag is mounted inside the vehicle and deployed.

23. The automobile side curtain airbag of claim 22, wherein the pre-tensioning device comprises a tether connected to the uninflatable zone, the tether resisting movement of the uninflatable zone away from the side structure of the vehicle when the side curtain airbag is mounted inside the vehicle and deployed.

24. The automobile side curtain airbag of claim 23, wherein the side curtain airbag has a top edge mountable near a roof on a side of the vehicle and a bottom edge extendable below the window opening on the side structure of the vehicle when the side curtain airbag is deployed.

25. The automobile side curtain airbag of claim 24, wherein the uninflatable zone is thinner than a material of the inflatable zones, the uninflatable zone is constructed of a material selected from the group consisting of netting, webbing, and mesh.

26. The automobile side curtain airbag of claim 24, wherein the uninflatable zone is a solid sheet.

27. The automobile side curtain airbag of claim 25, wherein the side curtain airbag has a front edge adjacent to an A-pillar of the vehicle and a rear edge adjacent to a C-pillar of the vehicle when the side curtain airbag is mounted inside the vehicle and deployed.

28. The automobile side curtain airbag of claim 27, wherein the first inflatable zone is located adjacent the top edge of the side curtain airbag, extending from adjacent a B-pillar towards the A-pillar of the vehicle when the side curtain airbag is mounted inside the vehicle and deployed.

29. The automobile side curtain airbag of claim 28, wherein the second inflatable zone is located adjacent a top edge of the side curtain airbag, extending from adjacent the C-pillar towards the B-pillar of the vehicle when the side curtain airbag is mounted inside the vehicle and deployed.

30. The automobile side curtain airbag of claim 29, wherein a portion of the uninflatable zone between the first and second inflatable zones is not perforated.

31. The automobile side curtain airbag of claim 25, further comprising a third inflatable zone for providing impact protection for a vehicle occupant in a rear seat of the vehicle when the side curtain airbag is mounted inside the vehicle and deployed.

32. The automobile side curtain airbag of claim 31, wherein the side curtain airbag has a front edge adjacent to an A-pillar of the vehicle and a rear edge adjacent to a D-pillar of the vehicle when the side curtain airbag is mounted inside the vehicle and deployed.

33. An automobile side curtain airbag assembly, comprising:
a first inflatable zone for providing impact protection for a vehicle occupant in a front seat of a vehicle;
a second inflatable zone for providing impact protection for a vehicle occupant in a rear seat of the vehicle;
an integral, perforated uninflatable zone extending below and between the first and second inflatable zones, the uninflatable zone being thinner than a material of either inflatable zones; and
a tethering system connected to a bottom edge of the uninflatable zone for maintaining the side curtain airbag adjacent a side structure of the vehicle when the side curtain airbag is mounted inside a vehicle and deployed.

34. An automobile side curtain airbag system, comprising:
an inflatable curtain;
a first inflatable zone in the inflatable curtain for providing impact protection for a vehicle occupant in a front seat of a vehicle;
a second inflatable zone in the inflatable curtain for providing impact protection for a vehicle occupant in a rear seat of the vehicle;
an integral uninflatable zone in the inflatable curtain extending below and between the first and second inflatable zones, the uninflatable zone being thinner than a material of either inflatable zones; and
an inflator.
